(19) United States
(12) Patent Application Publication
(10) Pub. No.: US 2026/0126896 A1
(43) Pub. Date: May 7, 2026

(54) GRAPHICAL USER INTERFACE FOR MANAGING RESOURCE ACCOUNTS

(71) Applicant: The Toronto-Dominion Bank, Toronto (CA)

(72) Inventor: James Charles FRANK, Denver, NC (US)

(73) Assignee: The Toronto-Dominion Bank, Toronto (CA)

(21) Appl. No.: 18/934,313

(22) Filed: Nov. 1, 2024

(51) Int. Cl. G06F 3/04842; G06F 3/0481; G06F 9/451

(52) U.S. Cl. CPC G06F 3/04842; G06F 3/0481; G06F 9/451

(57) ABSTRACT

A computer-implemented method is disclosed. The method includes: receiving, via a graphical user interface of a resource account management application, a first request to change a value of a first attribute of a defined resource allocation; responsive to receiving the first request: generating a graphical indicator that includes a deep link to a function of the resource account management application for modifying a related second attribute of the resource allocation; and presenting the graphical indicator in a portion of the GUI that is accessed at the time of receiving the first request.

### TECHNICAL FIELD

The present application relates to user interfaces and, more particularly, to a system and methods for providing graphical user interfaces that are used to manage resource accounts.

### BACKGROUND

Resource account management entails controlling access to resources associated with user accounts. An example implementation of resource account management is personal financial management (PFM) software. PFM software enables customers to manage their accounts through budgeting, expense tracking, and investment functionalities, among others. Data visualization of account data is crucial for effective usage of PFM software by customers. It is desired to provide a graphical user interface (GUI) that facilitates visualization of relevant account data and expedient access to actionable functionalities relating to resource account management.

### BRIEF DESCRIPTION OF THE DRAWINGS

Reference will now be made, by way of example, to the accompanying drawings which show example embodiments of the present application and in which:

FIG. 1 is a schematic diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 shows, in flowchart form, an example method for real-time control of a graphical user interface associated with a resource account management application;

FIG. 4 shows, in flowchart form, another example method for real-time control of a graphical user interface associated with a resource account management application;

FIG. 5 shows, in flowchart form, another example method for real-time control of a graphical user interface associated with a resource account management application.

Like reference numerals are used in the drawings to denote like elements and features.

### DETAILED DESCRIPTION OF EXAMPLE EMBODIMENTS

In an aspect, a computing system is disclosed. The computing system includes a processor and a memory coupled to the processor. The memory stores computer-executable instructions that, when executed by the processor, configure the processor to: receive, via a graphical user interface of a resource account management application, a first request to change a value of a first attribute of a defined resource allocation; responsive to receiving the first request: generate a graphical indicator that includes a deep link to a function of the resource account management application for modifying a related second attribute of the resource allocation; and present the graphical indicator in a portion of the GUI that is accessed at the time of receiving the first request.

In some implementations, the graphical indicator may comprise a user interface element for initiating a recommended application action within the graphical user interface.

In some implementations, the first request may comprise a user input for modifying the value of the first attribute of the resource allocation.

In some implementations, the second attribute may be an attribute associated with a second resource category that is different from a first resource category associated with the first attribute.

In some implementations, the instructions, when executed, may further configure the processor to: receive a second request to change a mode of the GUI to enable an alternate visualization of effects of the change in value of the first attribute; and present, via the GUI, a prompt for user input to modify a third attribute that is different from the first attribute of the resource allocation.

In some implementations, the instructions, when executed, may further configure the processor to present, via the GUI, a user interface element for controllably selecting a value of the third attribute, wherein the resultant changes of the resource allocation are displayed in real-time responsive to user action for manipulating the user interface element.

In some implementations, the instructions, when executed, may further configure the processor to: receive, via the GUI, selection of the deep link associated with the graphical indicator; and in response to receiving the selection of the deep link, automatically process modification of the second attribute of the resource allocation.

In some implementations, the instructions, when executed, may further configure the processor to: obtain account data of a first resource account, wherein generating the graphical indicator comprises determining at least one further modification of the second attribute of the resource allocation based on the obtained account data of the first resource account.

In some implementations, obtaining the account data of the first resource account may include detecting account activity associated with the first resource account that causes a change in at least one attribute of the resource allocation.

In some implementations, the instructions, when executed, may further configure the processor to: detect an account activity of the first resource account that results in a variance from the resource allocation; and present, via the GUI, a selectable option to initiate a transfer of resources based on the variance.

In another aspect, a computer-implemented method is disclosed. The method includes: receiving, via a graphical user interface of a resource account management application, a first request to change a value of a first attribute of a defined resource allocation; responsive to receiving the first request: generating a graphical indicator that includes a deep link to a function of the resource account management application for modifying a related second attribute of the resource allocation; and presenting the graphical indicator in a portion of the GUI that is accessed at the time of receiving the first request.

In yet another aspect, a non-transitory computer-readable storage medium is disclosed. The storage medium contains instructions thereon which, when executed by a processor, configure the processor to: receive, via a graphical user interface of a resource account management application, a first request to change a value of a first attribute of a defined resource allocation; responsive to receiving the first request: generate a graphical indicator that includes a deep link to a function of the resource account management application for modifying a related second attribute of the resource allocation; and present the graphical indicator in a portion of the GUI that is accessed at the time of receiving the first request.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

A novel graphical user interface (GUI) for resource account management software is proposed. The GUI allows users to define objectives and thresholds (e.g., maximum or minimum threshold) associated with one or more operations that can be performed in connection with their resource account. The operations may, for example, be automated actions such as scheduled transfers of defined quantities of resources from the account. In the context of PFM software, a user can input, using the GUI, resource account data such as, for example, income (e.g., monthly income), expenses (e.g., desired total expenses), etc. The expenses may be classified into one or more expense categories such as “housing”, “food”, “lifestyle”, “transportation”, and the like.

The GUI may visually indicate respective totals for each of the resource categories associated with a resource allocation and provide UI elements for modifying parameters associated with the categories. By way of example, the maximum threshold limit for an expense category (e.g., “housing”) may be increased based on user input of a new value for the limit. In response to a change in a resource category parameter based on user input, the GUI is configured to automatically present a graphical cue that includes a recommendation for modifying a second attribute of the resource allocation and a direct link to access said recommended modification. More generally, the GUI is configured to present a prompt for modifying second attribute(s) of a defined budget/resource allocation of a resource account responsive to a user request, received via input using the GUI, to modify a value of a specific attribute (or allocation category). The prompt may include a deep link for accessing a feature of the application to effect said modification of second attribute(s).

In PFM software, one example of such a modification of a resource allocation attribute is editing an attribute of a defined allocation objective, such as a savings goal. The GUI enables definition of one or more savings goals (e.g., vacation trip to a certain destination) and associated resource contributions/allocations specified by the user. By modifying the value of resource contribution/allocation, one or more attributes of the savings goal (e.g., end date for the saving) may be automatically updated and visually indicated in the GUI.

Alternatively, the GUI presents options for modifying the one or more attributes of the savings goal and displays the effects of such modifications on the user's contribution/allocation. The “new” values of contribution and monthly income % are automatically updated in response to user's manipulation of a UI element for controlling the attribute (i.e., end date) of the savings goal. The user can confirm a modification by confirming desired values of contribution/income %. More generally, the GUI supports real-time display of updated values of budget/resource allocation attributes responsive to user manipulation of a UI element for controllably selecting a value of a related budget attribute. In this way, the GUI facilitates a dual modification mechanism for altering budget attribute values—the user can edit either an expense attribute (e.g., monthly contribution to savings goal) or non-expense attribute (e.g., savings goal end date), with the resultant effect being that budget/resource allocation is automatically updated.

Surplus resources for a particular allocation category may be allocated to a different category using the GUI. Specifically, the GUI may prompt the user with an option to allocate any surplus resources to a different allocation category, by presenting a deep link to an edit feature within the application. For example, the deep link may be associated with an application action within the resource account management application suitable for handling the transfer of surplus resources between resource allocation categories.

Various technical solutions for providing customized user interfaces for managing resource accounts are described in the present disclosure.

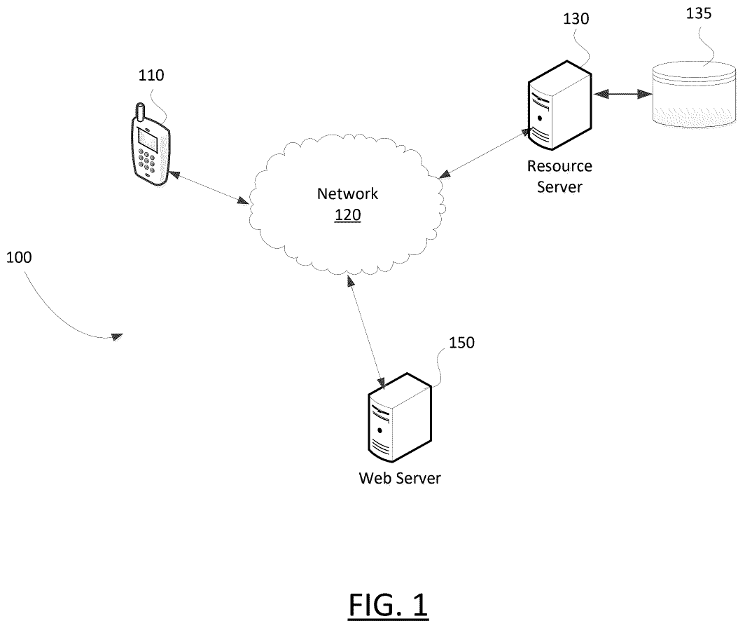

FIG. 1 illustrates an exemplary computing environment 100 consistent with certain disclosed embodiments. The computing environment 100 may include one or more client devices 110, a resource server 130, a database 135 associated with the resource server 130, a web server 150, and a communications network 120 connecting one or more of the components of computing environment 100.

As shown in FIG. 1, a resource server 130 (which may also be referred to as a server computer system) and client devices 110 communicate via the network 120. In at least some implementations, the client device 110 is a computing device. The client device 110 may take a variety of forms including, for example, a mobile communication device such as a smartphone, a tablet computer, a wearable computer such as a head-mounted display or smartwatch, a laptop or desktop computer, or a computing device of another type. The client device 110 is associated with a client entity having resources that are managed by or via the resource server 130. For example, the resource server 130 may be a financial institution server and the client entity may be a customer of a financial institution operating the financial institution server. The client device 110 may store software instructions that cause the client device to establish communications with the resource server 130 and, in some implementations, one or more electronic exchanges that are associated with markets (e.g., stock market, foreign exchange market, etc.).

The resource server 130 may track, manage, and maintain resources, make lending decisions, and/or lend resources to a client entity associated with the client device 110. The resources may, for example, be computing resources, such as memory or processor cycles. In at least some implementations, the resources may include stored value, such as fiat currency, which may be represented in a database. For example, the resource server 130 may be coupled to a database 135, which may be provided in secure storage. The secure storage may be provided internally within the resource server 130 or externally. The secure storage may, for example, be provided remotely from the resource server 130. For example, the secure storage may include one or more data centers. The data centers may, for example, store data with bank-grade security.

The database 135 may include records for a plurality of resource accounts and at least some of the records may define a quantity of resources associated with the client entity. For example, the client entity may be associated with an account having one or more records in the database 135. The records may reflect a quantity of stored resources that are associated with the client entity. Such resources may include owned resources and, in at least some implementations, borrowed resources (e.g., resources available on credit). The quantity of resources that are available to or associated with the client entity may be reflected by a balance defined in an associated record such as, for example, a bank balance.

In at least some implementations, the database 135 may store various types of information in connection with customers of a business entity that administers the resource server 130. For example, the database 135 may store customer profile data and financial account data associated with customers. The customer profile data may include, without limitation, personal information of registered customers, authentication credentials of the customers, account identifying information, and information identifying products (e.g., checking account, savings account, revolving credit line, etc.) and services (e.g., resource loan services, investment management services, etc.) that are offered to the customers by the business entity. The financial account data may include portfolio data relating to portfolios of investments that are held by customers. A customer's portfolio data may include, for example, information identifying actual positions held by the customer in various securities, information identifying a “virtual” portfolio composed of simulated positions held by the customer in various securities, and “watch lists” specifying various securities that are monitored by the customer.

The business entity associated with the resource server 130 may provide services that are accessible to the client entity. For example, the business entity may be a financial institution that can provide account management services, financial transaction services, and wealth management services for the client entity. In at least some implementations, the resource server 130 may be configured to provide a user interface that allows client devices 110 to access the services offered by the business entity. By way of example, the resource server 130 may be configured to provide a website or web-based portal which can be accessed via the client devices 110. The website (or portal) may include web content corresponding to various services that are offered by the business entity, and the resource server 130 may provide the web content for display on client devices 110. As another example, the resource server 130 may be associated with a software application which may be installed and/or run on the client devices 110. The software application may, for example, be a dedicated mobile banking app that is provided for use on client devices 110, and the resource server 130 may be a backend application server associated with the app.

The resource server 130 may administer a resource account management platform for managing resource accounts. The resource account management platform may be accessible via client devices 110. For example, the resource account management platform may be accessed using a web interface on the client devices 110. Additionally, or alternatively, the resource account management platform may be provided via a graphical user interface of an application, different from a web browser, operating on the client device 110. For example, an account management application may be stored in memory of the client device 110 and executed thereon for accessing features and functions of the resource account management platform.

The client devices 110, the resource server 130, and the web server 150 may be in geographically disparate locations. Put differently, the client device 110 may be remote from one or both of the resource server 130 and the web server 150. As described above, the client device 110, the resource server 130, and the web server 150 may be computer systems.

The network 120 is a computer network. In some implementations, the network 120 may be an internetwork such as may be formed of one or more interconnected computer networks. For example, the network 120 may be or may include an Ethernet network, an asynchronous transfer mode (ATM) network, a wireless network, or the like.

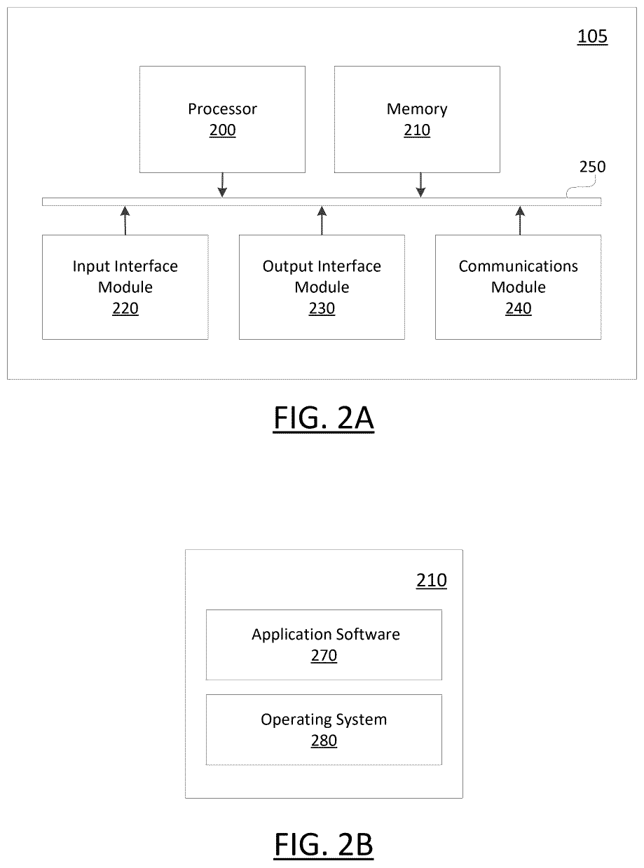

FIG. 2A is a high-level operation diagram of an example computing device 105. In some implementations, the example computing device 105 may be exemplary of one or more of the client devices 110, the resource server 130, and the web server 150. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some implementations, all or a portion of the input interface module 220 may be integrated with an input device. For example, the input interface module 220 may be integrated with one of the aforementioned input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some implementations, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some implementations, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated these software components include an operating system 280 and application software 270.

The operating system 280 is software. The operating system 280 allows the application software 270 to access the processor 200, the memory 210, the input interface module 220, the output interface module 230 and the communications module 240. The operating system 280 may be, for example, Apple iOS™, Android™, Linux™, Microsoft Windows™, or the like.

The application software 270 adapts the example computing device 105, in combination with the operating system 280, to operate as a device performing particular functions. The application software 270 may, for example, comprise a resource account management application. The resource account management application may provide various functions such as resource transfers (e.g., electronic fund transfers, etc.), display of account balances, and other account management functions. The resource account management application may, for example, be a personal financial management (PFM) application such as a banking application. A PFM application allows users to track expenses, balances, savings, etc. and facilitates personal budgeting. A PFM application may be used to define budget constraints (e.g., weekly or monthly spending limits), analyze historical and projected spending data, and to define various savings goals in connection with one or more banking accounts.

The resource account management application may be a stand-alone application, such as a mobile app, or integrated into another application or software module resident on the example computing device 105 as a sub-function or feature. The resource account management application is associated with a backend application server. In at least some implementations, a server which manages resource accounts associated with the customers of a business entity, such as the resource server 130 of FIG. 1, may also serve as the backend application server for the resource account management application. In particular, various functions of the resource account management application may be provided, at least in part, by a resource server associated with a bank institution. That is, the resource server may perform at least some of the backend services of the resource account management application.

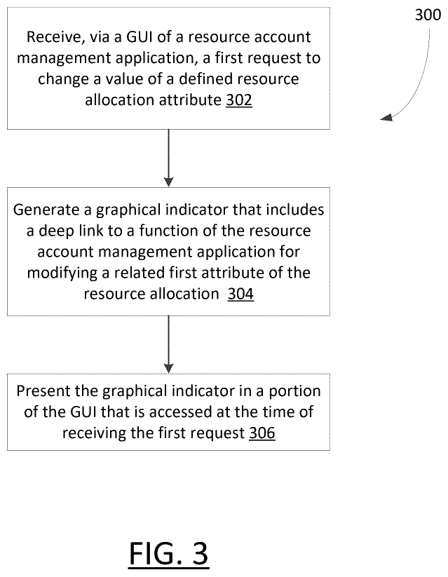

Reference is made to FIG. 3, which shows, in flowchart form, an example method 300 for real-time control of a graphical user interface associated with a resource account management application. Operations 302 and onward may be performed by one or more processors of a computing system such as, for example, the processor 200 of one or more suitably configured instances of the example computing device 105 (FIG. 2A). In at least some implementations, a server (such as the resource server 130 of FIG. 1) that is configured to support operations for managing a plurality of resource accounts may perform all or part of the operations of method 300.

A computing system may receive, via a client computing device, a request to access a graphical user interface associated with a resource account management application. The graphical user interface may, for example, be a website, a web application, a dedicated mobile application, and the like, that can be used to manage a plurality of resource accounts. The computing system may be configured to detect when a user requests to launch a graphical user interface for accessing their account, and associated account data, on the resource account management platform.

The graphical user interface enables users to selectively conduct account operations for managing resources associated with their resource accounts. As a specific example, users may define a “resource allocation” in connection with the resources of their account. A resource allocation may specify how resources are to be allocated towards one or more defined transfer operations (e.g., scheduled operations) associated with the resource account. By way of example, a resource allocation may identify a plurality of allocation categories corresponding to various transfer operations that can be conducted in connection with the resources of a user's account. The resource allocation may also indicate quantities of resources that are allocated/designated toward each of the categories.

An initial resource allocation for a resource account may be defined by the user. In particular, the user may provide, using the graphical user interface of the resource account management application, resource allocation data for an initial allocation comprising one or more categories of transfer operations and respective quantities of resources for allocation. The initial allocation may subsequently be adjusted, manually by the user or otherwise, to produce one or more adjusted allocations of resources of the user's account.

In operation 302, the computing system receives, via the graphical user interface of the resource account management application, a first request to change a value of a first attribute of a defined resource allocation. The first request may, for example, comprise a user input for modifying a value of the first attribute. An “attribute” of a resource allocation refers to a modifiable property of the resource allocation. Examples of resource allocation attributes include, among others, a per-category (or per-transfer) allocation threshold (e.g., maximum allocation limit, minimum allocation limit, etc.), an allocated quantity of resources, a desired quantity of allocated resources, a schedule of allocation(s) and/or associated transfer operations, and the like. A user associated with a resource account may input, using the graphical user interface, a value for modifying the first attribute of the resource allocation for the resource account as part of the first request.

Upon receiving the first request, the computing system generates a graphical indicator that facilitates modification, by the user, of a related second attribute of the resource allocation (operation 304). More specifically, a graphical cue that includes a deep link to a function of the resource account management application is generated by the computing system. The function enables modifying the second attribute of the resource allocation. The second attribute may, for example, be an attribute associated with a second resource category that is different from a first resource category associated with the first attribute. In particular, the second attribute may be a resource allocation attribute that is different from the first attribute. By way of example, the first attribute may be a per-category allocation threshold (e.g., maximum allocation limit) for a first category of allocation (e.g., “housing”), and the second attribute may be a per-category allocation threshold (e.g., maximum allocation limit) for a second category (e.g., “lifestyle”) that is different from the first category.

The deep link enables direct access by the user of one or more account operations for modifying the second attribute. In at least some implementations, the graphical indicator is presented in the form of recommended application actions that are accessible within the graphical user interface. Each of the recommended application actions may be associated with a respective deep link and graphically represented in the GUI. In particular, the computing system presents the graphical indicator, including the associated deep link(s), in the GUI, in operation 306. The graphical indicator is presented in a portion of the GUI that is accessed at the time of receiving the first request. By way of example, the graphical indicator may be displayed as a pop-up, or other type of overlay, on a page of the resource account management application that is accessed by the user when changing a value of the first attribute.

The user may select a deep link associated with the graphical indicator. For example, the user may actuate a deep link (or an associated user interface element) to signal a selection. In some implementations, in response to receiving the selection of the deep link, the computing system may automatically process modification of the second attribute of the resource allocation. That is, the selection of the deep link may initiate a certain application action that is performed automatically, i.e., without user input, for adjusting the second attribute. Alternatively, the selection of the deep link may launch a defined function of the resource account management application that enables the user to manually modify the second attribute. For example, the deep link may cause a new page (or other interface) associated with the function to be launched, and the user may provide further input via the new page/interface for defining a replacement value for the second attribute.

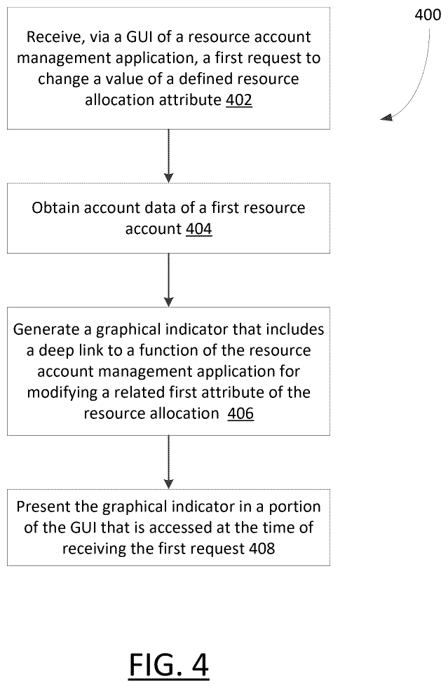

Reference is made to FIG. 4, which shows, in flowchart form, another example method 400 for real-time control of a graphical user interface associated with a resource account management platform. Operations 402 and onward may be performed by one or more processors of a computing system such as, for example, the processor 200 of one or more suitably configured instances of the example computing device 105 (FIG. 2A). In at least some implementations, a server (such as the resource server 130 of FIG. 1) that is configured to support operations for managing a plurality of resource accounts may perform all or part of the operations of method 400. The operations of method 400 may be performed in addition to, or as alternatives of, one or more of the operations of method 300 of FIG. 3.

An initial resource allocation may be defined for a first resource account. In particular, a user may input, using the graphical user interface of a resource account management application, resource allocation data for an initial allocation of resources. The initial allocation may specify one or more categories of transfer operations and respective quantities of resources for allocation in connection with the first resource account. Any changes to the initial allocation may be processed to determine adjusted allocations of resources. That is, the initial allocation may be adjusted, manually by the user or otherwise, to produce one or more adjusted allocations of resources of the first resource account.

The computing system receives, via the graphical user interface, a first request to change a value of a first attribute for the resource allocation (operation 402). The first request may, for example, comprise a user input, received using the GUI, for modifying a value of the first attribute. The user input may include an indication of a new value for use in replacing the current value of the first attribute.

In operation 404, the computing system obtains account data of the first resource account. More particularly, the account data may be retrieved in real-time to obtain current information regarding the first resource account. For example, the computing system may detect account activity associated with the first resource account. The account activity may comprise one or more account operations conducted in connection with the first resource account. The account operations may be operations that cause, individually or collectively, a change in at least one attribute of the resource allocation. By way of example, the account operations may include transfers of resources to and/or from the first resource account.

Upon receiving the first request and obtaining the account data of the first resource account, the computing system generates a graphical indicator that facilitates modification, by the user, of a second attribute of the resource allocation (operation 406). More specifically, a graphical cue that includes a deep link to a function of the resource account management application is generated by the computing system. The function enables modifying the second attribute of the resource allocation. The second attribute may, for example, be an attribute associated with a second resource category that is different from a first resource category associated with the first attribute. In particular, the second attribute may be a resource allocation attribute that is different from the first attribute. By way of example, the first attribute may be a per-category allocation threshold (e.g., maximum allocation limit) for a first category of allocation (e.g., “housing”), and the second attribute may be a per-category allocation threshold (e.g., maximum allocation limit) for a second category (e.g., “lifestyle”) that is different from the first category.

In some implementations, the computing system determines at least one further modification of the first attribute of the resource allocation. In operation 408, the computing system presents the graphical indicator in the GUI. In particular, the graphical indicator is presented in a portion of the GUI that is accessed at the time of receiving the first request.

The user may select a deep link associated with the graphical indicator. For example, the user may actuate a deep link (or an associated user interface element) to signal a selection. In some implementations, in response to receiving the selection of the deep link, the computing system may automatically process modification of the second attribute of the resource allocation. That is, the selection of the deep link may initiate a certain application action that is performed automatically, i.e., without user input, for adjusting the second attribute. Alternatively, the selection of the deep link may launch a defined function of the resource account management application that enables the user to manually modify the second attribute.

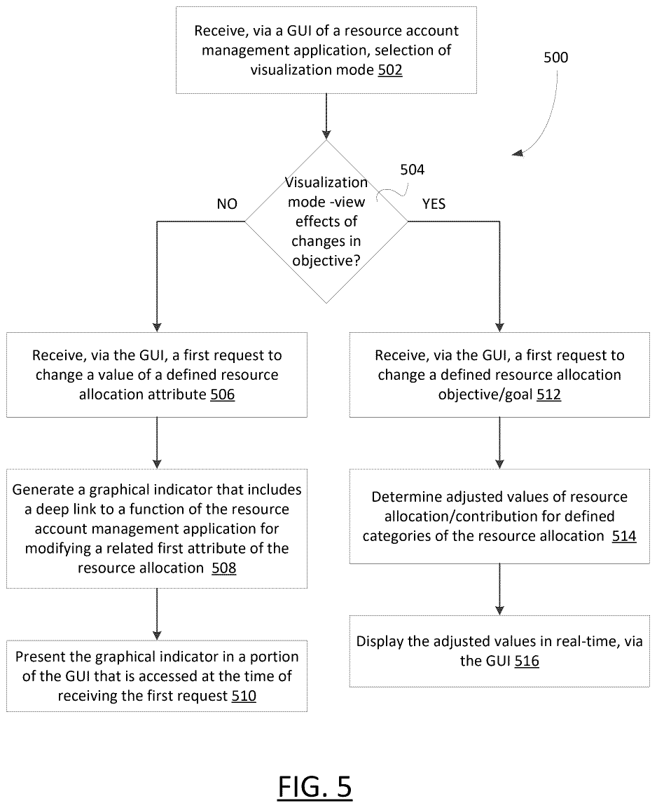

Reference is made to FIG. 5, which shows, in flowchart form, another example method 500 for real-time control of a graphical user interface associated with a resource account management platform. Operations 502 and onward may be performed by one or more processors of a computing system such as, for example, the processor 200 of one or more suitably configured instances of the example computing device 105 (FIG. 2A). In at least some implementations, a server (such as the resource server 130 of FIG. 1) that is configured to support operations for managing a plurality of resource accounts may perform all or part of the operations of method 500. The operations of method 500 may be performed in addition to, or as alternatives of, one or more operations of methods 300 and 400. In particular, the method 500 may be implemented as part of a process for determining priorities of features and functions that are offered on a resource account management platform.

In operation 502, the computing system receives, via a graphical user interface of a resource account management application, selection of a visualization mode. The visualization modes available for selection may include, at least, a first mode that enables visualization of a current resource allocation for a resource account and a second mode that enables visualization of allocation objectives for the resource account. The current resource allocation is linked with and corresponds to the allocation objectives such that an intentional change to one has a direct effect on the other. In particular, by changing an attribute of the current resource allocation, one or more components of the allocation objectives may be automatically adjusted. Similarly, by changing an attribute of an allocation objective, the current resource allocation may be caused to adjust accordingly.

In operation 504, the computing system determines the mode that is selected by the user. If the first mode is selected, the computing system receives, via the graphical user interface, a first request to change a value of a first attribute for the resource allocation (operation 506). The first request may, for example, comprise a user input, received using the GUI, for modifying a value of the first attribute. The user input may include an indication of a new value for use in replacing the current value of the first attribute.

In operation 508, the computing system generates a graphical indicator that facilitates modification, by the user, of a second attribute of the resource allocation. A graphical cue that includes a deep link to a function of the resource account management application is generated by the computing system. The function enables modifying the second attribute of the resource allocation. The second attribute may, for example, be an attribute associated with a second resource category that is different from a first resource category associated with the first attribute. The graphical indicator is then presented via the GUI (operation 510) in a portion of the GUI that is accessed at the time of receiving the first request.

If, on the other hand, the second visualization mode is selected by the user, the computing system receives, via the GUI, a first request to change a defined allocation objective for the resource allocation (operation 512). The computing system may present, via the GUI, a prompt for user input to modify a third attribute (of an allocation objective) that is different from the first attribute of the resource allocation. In some implementations, the computing system may present, via the GUI, a user interface element for controllably selecting a value of the third attribute, wherein the resultant changes of the resource allocation are displayed in real-time responsive to user action for manipulating the user interface element.

In operation 514, the computing system determines adjusted values of resource allocation/contribution for defined categories of the resource allocation. In particular, the adjusted values of resource allocation/contribution are determined based on the parameters of the first request for changing the allocation objective of the resource allocation.

The adjusted values of the resource allocation/contribution are then displayed, in real-time, via the GUI of the resource account management application (operation 516).

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor; and
a memory coupled to the processor, the memory storing computer-executable instructions that, when executed by the processor, configure the processor to:
receive, via a graphical user interface of a resource account management application, a first request to change a value of a first attribute of a defined resource allocation;
responsive to receiving the first request:
generate a graphical indicator that includes a deep link to a function of the resource account management application for modifying a related second attribute of the resource allocation; and
present the graphical indicator in a portion of the graphical user interface that is accessed at the time of receiving the first request.

2. The computing system of claim 1, wherein the graphical indicator comprises a user interface element for initiating a recommended application action within the graphical user interface.

3. The computing system of claim 1, wherein the first request comprises a user input for modifying the value of the first attribute of the resource allocation.

4. The computing system of claim 1, wherein the second attribute is an attribute associated with a second resource category that is different from a first resource category associated with the first attribute.

5. The computing system of claim 1, wherein the instructions, when executed, further configure the processor to:
receive a second request to change a mode of the graphical user interface to enable an alternate visualization of effects of the change in value of the first attribute; and
present, via the graphical user interface, a prompt for user input to modify a third attribute that is different from the first attribute of the resource allocation.

6. The computing system of claim 5, wherein the instructions, when executed, further configure the processor to present, via the graphical user interface, a user interface element for controllably selecting a value of the third attribute, wherein the resultant changes of the resource allocation are displayed in real-time responsive to user action for manipulating the user interface element.

7. The computing system of claim 1, wherein the instructions, when executed, further configure the processor to:
receive, via the graphical user interface, selection of the deep link associated with the graphical indicator; and
in response to receiving the selection of the deep link, automatically process modification of the second attribute of the resource allocation.

8. The computing system of claim 1, wherein the instructions, when executed, further configure the processor to:
obtain account data of a first resource account, wherein generating the graphical indicator comprises determining at least one further modification of the second attribute of the resource allocation based on the obtained account data of the first resource account.

9. The computing system of claim 8, wherein obtaining the account data of the first resource account comprises detecting account activity associated with the first resource account that causes a change in at least one attribute of the resource allocation.

10. The computing system of claim 8, wherein the instructions, when executed, further configure the processor to:
detect an account activity of the first resource account that results in a variance from the resource allocation; and
present, via the graphical user interface, a selectable option to initiate a transfer of resources based on the variance.

11. A computer-implemented method, comprising:
receiving, via a graphical user interface of a resource account management application, a first request to change a value of a first attribute of a defined resource allocation;
responsive to receiving the first request:
generating a graphical indicator that includes a deep link to a function of the resource account management application for modifying a related second attribute of the resource allocation; and
presenting the graphical indicator in a portion of the graphical user interface that is accessed at the time of receiving the first request.

12. The method of claim 11, wherein the graphical indicator comprises a user interface element for initiating a recommended application action within the graphical user interface.

13. The method of claim 11, wherein the first request comprises a user input for modifying the value of the first attribute of the resource allocation.

14. The method of claim 11, wherein the second attribute is an attribute associated with a second resource category that is different from a first resource category associated with the first attribute.

15. The method of claim 11, further comprising:
receiving a second request to change a mode of the graphical user interface to enable an alternate visualization of effects of the change in value of the first attribute; and
presenting, via the graphical user interface, a prompt for user input to modify a third attribute that is different from the first attribute of the resource allocation.

16. The method of claim 15, further comprising presenting, via the graphical user interface, a user interface element for controllably selecting a value of the third attribute, wherein the resultant changes of the resource allocation are displayed in real-time responsive to user action for manipulating the user interface element.

17. The method of claim 11, further comprising:
receiving, via the graphical user interface, selection of the deep link associated with the graphical indicator; and
in response to receiving the selection of the deep link, automatically processing modification of the second attribute of the resource allocation.

18. The method of claim 11, further comprising:
obtaining account data of a first resource account, wherein generating the graphical indicator comprises determining at least one further modification of the second attribute of the resource allocation based on the obtained account data of the first resource account.

19. The method of claim 18, wherein obtaining the account data of the first resource account comprises detecting account activity associated with the first resource account that causes a change in at least one attribute of the resource allocation.

20. The method of claim 18, further comprising:
detecting an account activity of the first resource account that results in a variance from the resource allocation; and
presenting, via the graphical user interface, a selectable option to initiate a transfer of resources based on the variance.
